(19) United States
(12) Patent Application Publication
(10) Pub. No.: US 2021/0286415 A1
(43) Pub. Date: Sep. 16, 2021

(54) DISPLAY APPARATUS AND METHOD OF MANUFACTURING THE SAME

(71) Applicant: SAMSUNG ELECTRONICS CO., LTD., Suwon-si, Gyeonggi-do (KR)

(72) Inventors: Sang Baek KIM, Seoul (KR); Kwang Sung HWANG, Suwon-si (KR)

(73) Assignee: SAMSUNG ELECTRONICS CO., LTD., Suwon-si, Gyeonggi-do (KR)

(21) Appl. No.: 17/263,656

(22) PCT Filed: Sep. 13, 2018
(86) PCT No.: PCT/KR2018/010792

§ 371 Date: Jan. 27, 2021

(30) Foreign Application Priority Data
Jul. 27, 2018 (KR) 10-2018-0087836

(51) Int. Cl. G06F 1/18; G09F 9/302

(52) U.S. Cl. CPC G06F 1/181; G09F 9/3026

(57) ABSTRACT

The present disclosure relates to a method of manufacturing a display apparatus. The method includes coupling one or more correction members to a frame on which a plurality of display panels is to be mounted thereon, seating the frame on a correction jig formed flat, checking whether gaps are generated between the one or more correction members and the correction jig, moving and seating the frame to and on a processing jig, and forming panel seating parts on the frame seated on the processing jig using a processing device.

### TECHNICAL FIELD

The present disclosure relates to a display apparatus and a method of manufacturing the same, and more particularly, to a display apparatus having a plurality of display modules and a method of manufacturing the same.

### BACKGROUND ART

A display apparatus is an apparatus that converts and displays electrical information into visual information. The display apparatus includes a self-light emitting display panel that emits light itself, such as an LED panel (Light Emitting Diode Panel), or includes a light-receiving/emitting display panel that does not emit light itself and needs to be supplied with light from a backlight unit, such as a liquid crystal panel.

When producing a large-sized display apparatus, a modular display technology in which a large-sized screen is produced by continuously tiling a small-sized display panel vertically and horizontally may be utilized. Furthermore, a larger sized screen may be provided by connecting a plurality of the display modules produced by tiling a small sized display panel.

However, a plurality of frames on which a plurality of display panels is mounted may be finely bent during a manufacturing process. The plurality of frames have different degrees of being bent, and thus a step difference is generated between a plurality of display modules of a display apparatus that is connected to each other.

### DISCLOSURE

### Technical Problem

The present disclosure is directed to providing a display apparatus including a display module capable of reducing a step difference generated between a plurality of display panels and a method of manufacturing the same.

The present disclosure is directed to providing a display apparatus capable of improving a manufacturing process and a method of manufacturing the same.

### Technical Solution

An aspect of the present disclosure provides a display apparatus including a plurality of display panels, a frame including panel seating parts on which the plurality of display panels is mounted and having a correction hole formed to penetrate along the front and rear directions, and a control board disposed at the rear of the frame, wherein the correction hole is provided such that a correction member to support a rear surface of the frame when the panel seating part is processed on the frame is inserted, and the correction member is configured such that a degree of being inserted into the correction hole when the panel seating part is processed on the frame is adjusted.

The correction hole may be formed at the rear of at least one of the plurality of display panels.

The frame may include an installation groove in which the display panel is mounted and a connection opening formed such that the display panel and the control board are electrically connected.

The correction hole may have threads formed on an inner circumferential surface thereof, and the correction member may include a member body on which threads are formed to correspond to the correction hole.

The correction member may include a member head provided at one end of the member body to be in contact with a processing jig on which the frame is seated when the panel seating part is processed on the frame, and a control groove provided at the other end opposite to the one end of the member body to receive an external force when a degree of being inserted into the correction hole is adjusted.

Another aspect of the present disclosure provides a method of manufacturing a display apparatus including coupling one or more correction members to a frame on which a plurality of display panels is to be mounted thereon, seating the frame on a correction jig formed flat, adjusting the correction members so that the one or more correction members and the correction jig are all in contact with each other, moving and seating the frame to and on a processing jig, and forming panel seating parts on the frame seated on the processing jig using a processing device.

The method may further include checking whether gaps are generated between the one or more correction members and the correction jig before adjusting the correction members and then adjusting the correction member generating the gap together with the correction jig.

The method may further include moving the correction member, which generates the gap together with the correction jig among the one or more correction members, by a predetermined distance in a direction of being separated from the frame.

The method may further include separating the one or more correction members from the frame after forming the panel seating parts on the frame.

The method may further include forming correction holes so that the one or more correction members are inserted into the frame before coupling the one or more correction members to the frame.

The one or more correction members may be provided to be screwed into the correction holes and have a control groove formed to receive an external force.

The correction holes may be formed to correspond to the number of the one or more correction members.

The method may further include fixing the frame seated on the processing jig through a clamp.

The clamp may press a portion of the frame into which the one or more correction members are inserted.

The panel seating parts may be formed parallel to surfaces into which the one or more correction members and the correction jig are in contact.

The panel seating parts may be formed to support edges of rear surfaces of the plurality of display panels.

The processing device may be provided as a milling machine.

The frame may be provided by die casting.

The method may further include applying an external force to the frame in a direction in which the frame is flattened before coupling the one or more correction members to the frame.

Another aspect of the present disclosure provides a method of manufacturing a display apparatus including forming correction holes on a frame on which a plurality of display panels is to be mounted thereon, coupling one or more correction members to the correction holes of the frame, seating the frame on a correction jig formed flat, checking whether gaps are generated between the one or more correction members and the correction jig and then adjusting the correction member generating the gap together with the correction jig to be in contact with the correction jig, moving and seating the frame to and on a processing jig, fixing the frame seated on the processing jig through a clamp, and forming panel seating parts on the frame seated on the processing jig using a processing device.

### Advantageous Effects

In a display apparatus according to the present disclosure, after a reference point depending on a thickness direction of a frame is corrected, a work for flattening a display seating part is performed, so that a step difference generated between a plurality of display panels can be reduced.

In a method of manufacturing the display apparatus according to the present disclosure, a degree to which the frame is bent is corrected before the frame is seated on a processing device, so that a manufacturing process can be relatively simplified.

### DESCRIPTION OF DRAWINGS

FIG. 1 illustrates an outer appearance of a display apparatus according to an embodiment of the present disclosure.

FIG. 2 is an exploded perspective view of a display module illustrated in FIG. 1.

FIG. 3 illustrates that a correction member is coupled to a frame illustrated in FIG. 2.

FIG. 4 illustrates a state in which the correction member is coupled to the frame illustrated in FIG. 3.

FIG. 5 illustrates a state in which the frame illustrated in FIG. 4 is seated on a correction jig.

FIG. 6 is an enlarged view of part A illustrated in FIG. 5.

FIG. 7 illustrates that a panel seating part is processed in the frame illustrated in FIG. 5.

FIG. 8 illustrates a state in which the panel seating part is processed in the frame illustrated in FIG. 7.

FIG. 9 is a flowchart illustrating a method of manufacturing a frame of a display apparatus according to an embodiment of the present disclosure.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

The singular expressions herein may include plural expressions, unless the context clearly dictates otherwise. In the drawings, the shapes and sizes of components may be exaggerated for convenience. Like reference numbers or signs in the drawings of the application represent parts or components that perform substantially the same functions.

The terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms “first,” “second,” etc. may be used herein to describe various components, these components should not be limited by these terms.

Hereinafter, embodiments of the present disclosure will be described in detail with reference to the accompanying drawings.

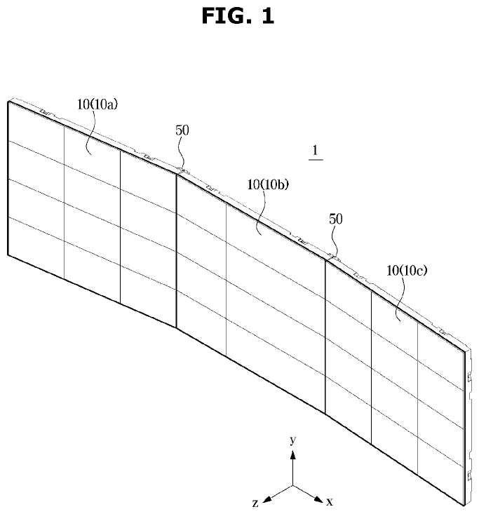

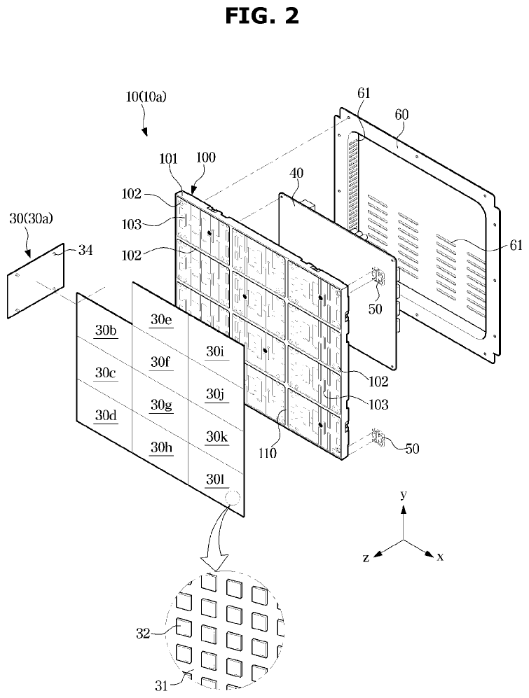

FIG. 1 illustrates an outer appearance of a display apparatus according to an embodiment of the present disclosure. FIG. 2 is an exploded perspective view of a display module illustrated in FIG. 1.

Referring to FIGS. 1 and 2, a display apparatus 1 is an apparatus that displays information, materials, data, and the like as characters, figures, graphs, images, and the like, and may include an advertising panel, an electronic display, a screen, a television, a monitor, and the like. The display apparatus 1 may be installed indoors or outdoors ground by a stand (not shown) or may be installed on a wall through a wall mount (not shown).

The display apparatus 1 may include a plurality of display modules 10 and a connection member 50 connecting the plurality of display modules 10 to each other. In the present embodiment, the display apparatus 1 is composed of three of display modules 10a to 10c, but is not limited thereto, and the number of the display modules 10 is not limited.

The plurality of display modules 10 may be continuously connected to each other in the left and right directions. The plurality of display modules 10 may be connected to each other in parallel, and may be connected to be curved in a concave shape toward the front when viewed from the top of the display apparatus 1 as illustrated in FIG. 1. Conversely, the plurality of display modules 10 may be connected to be curved in a convex shape toward the front when viewed from the top of the display apparatus 1, or may be connected to alternately form a concave shape and a convex shape.

That is, the screen itself of the display module 10 is flat, but the display apparatus 1 may be implemented to have a curved screen by adjusting an angle between the plurality of display modules 10 when the plurality of display modules 10 are connected.

As illustrated in FIG. 2, the display module 10 may be composed of at least one display panel 30 and a frame 100 in which the at least one display panel 30 is installed. In the present embodiment, the display module 10 includes twelve of display panels 30a to 301 arranged as 4*3 matrices, but the number or arrangement of the display panels 30 is not limited. Each of the display panels 30 may be independently installed in or separated from the frame 100.

As such, by installing the plurality of display panels 30 in the frame 100 by tiling in the form of a matrix at front, rear, left and right, a large-sized screen may be implemented using the display panels 30 having a small-sized screen. Also, by connecting the plurality of display modules 10 composed of the plurality of display panels 30 to each other by the connection member 50, a larger sized screen may be implemented.

The display panel 30 may include a plurality of light sources 32 and a substrate 31 on which the plurality of light sources 32 is mounted. The plurality of light sources 32 may be arranged at a certain distance from each other. An installation member 34 for installing the display panel 30 in the frame 100 may be provided on a rear surface of the display panel 30.

The frame 100 may include a frame body 101. The frame body 101 may be provided to support the plurality of display panels 30. The frame body 101 may be configured to correspond to a size and/or shape in which the plurality of display panels 30 is arranged.

The frame 100 may include a panel seating part 110. The panel seating part 110 may be formed on a front surface of the frame body 101. The panel seating part 110 may be a portion protruding from the front surface of the frame body 101. The panel seating part 110 may be formed to support an edge of the display panel 30. The display panel 30 may be installed on a front surface of the panel seating part 110.

An installation groove 102 into which the installation member 34 of the display panel 30 is inserted may be formed on the panel seating part 110. The installation groove 102 may be formed to penetrate the frame body 101 in the front and rear directions. The installation member 34 may be firmly fixed by a fixing member (not shown) after being inserted into the installation groove 102. The fixing member may include a magnet.

A control board 40 configured to supply power to the display panel 30 or control the operation of the display panel 30 may be disposed at the rear of the frame 100. The control board 40 may be electrically connected to the display panel 30 through a connection opening 103. The connection opening 103 may be formed to penetrate the frame body 101 in the front and rear directions.

A rear cover 60 may be disposed at the rear of the control board 40. The rear cover 60 may be coupled to the rear of the frame 100. The rear cover 60 may be configured to cover the control board 40 to protect the control board 40. The rear cover 60 may include a heat radiation slit 61 for heat radiation. The heat radiation slit 61 may be formed on a rear and/or side surface of the rear cover 60.

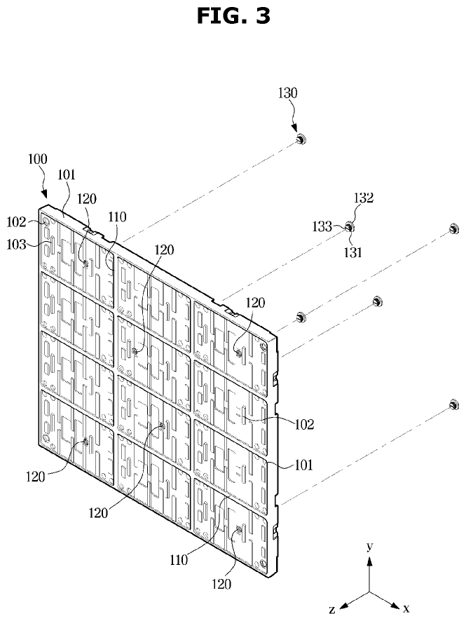

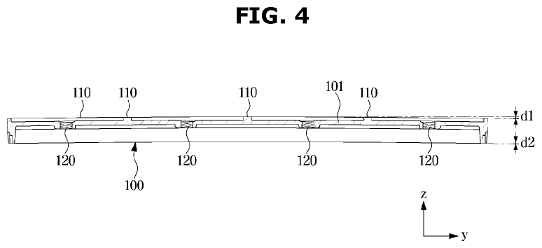

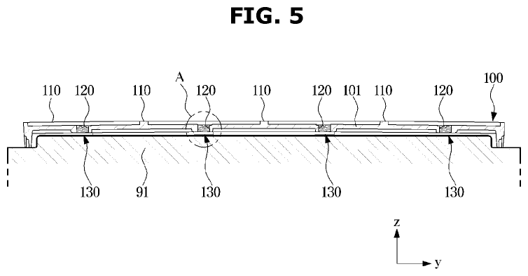

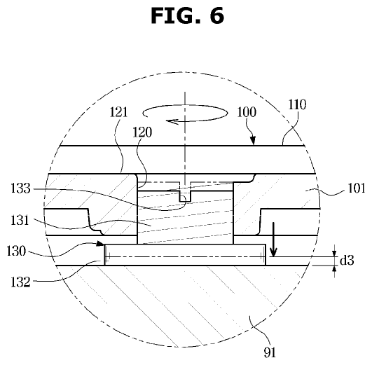

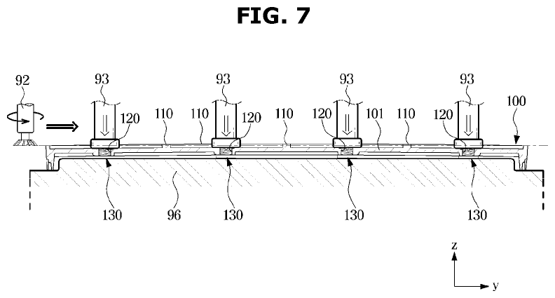

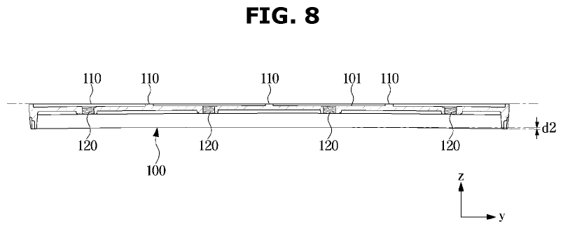

FIG. 3 illustrates that a correction member is coupled to a frame illustrated in FIG. 2. FIG. 4 illustrates a state in which the correction member is coupled to the frame illustrated in FIG. 3. FIG. 5 illustrates a state in which the frame illustrated in FIG. 4 is seated on a correction jig. FIG. 6 is an enlarged view of part A illustrated in FIG. 5. FIG. 7 illustrates that a panel seating part is processed in the frame illustrated in FIG. 5. FIG. 8 illustrates a state in which the panel seating part is processed in the frame illustrated in FIG. 7.

Referring to FIG. 3, the frame 100 may include a correction hole 120 to which a correction member 130 is coupled when the panel seating part 110 on which the display panel 30 is seated is processed. The correction member 130 may be provided to support a rear surface of the frame 100. The correction hole 120 may be formed to penetrate the frame body 101 in the front and rear directions. The correction holes 120 may be provided in a number corresponding to the number of the correction members 130. Because six of the correction members 130 are provided, FIG. 3 illustrates that six of the correction holes 120 are formed. However, the number of the correction holes 120 is not limited thereto, and may be larger than the number of the correction members 130 to be coupled. The correction hole 120 may be formed at the rear of at least one of the plurality of display panels 30 mounted on the frame 100.

The correction member 130 may be inserted into the correction hole 120 of the frame 100. The correction member 130 may be provided such that a degree of being inserted into the frame 100 is adjusted. The correction member 130 may support the frame 100 so that the frame 100 may be flatly seated on a processing jig 96 when the panel seating part 110 is processed on the frame 100. The correction member 130 may be a screw threaded, and threads may be formed on an inner circumferential surface of the correction hole 120.

FIG. 3 illustrates that six of the correction members 130 are provided. However, the number of the correction members 130 is not limited thereto, and five or less or seven or more of the correction members 130 may be provided. The correction member 130 may include a member body 131, a member head 132, and a control groove 133 (see FIG. 6).

The member body 131 is formed in a substantially cylindrical shape, and threads may be formed along an outer circumferential surface thereof. The threads of the member body 131 may be formed to correspond to the threads of the correction hole 120.

The member head 132 is disposed at one end of the member body 131 and may have a larger radius than the member body 131. The member head 132 may be seated on the processing jig 96. The member head 132 may be disposed to be in contact with the processing jig 96.

The control groove 133 may be formed at the other end opposite to the one end of the member body 131 at which the member head 132 is disposed. The control groove 133 may be provided to receive an external force for controlling the degree to which the correction member 130 is inserted into the correction hole 120. The control groove 133 may be provided in a size and/or shape corresponding to a control tool so that the degree to which the correction member 130 is inserted into the correction hole 120 may be easily adjusted.

By adjusting the degree to which the correction member 130 is coupled to the correction hole 120, when seated on the processing jig 96, the frame 100 may coincide with a reference line along a horizontal direction. As the degree to which the correction member 130 is coupled to the correction hole 120 is adjusted, the frame 100 may be aligned with a reference line along a z axis direction.

Specifically, referring to FIG. 4, a flattening work may be performed by applying a physical force to the frame 100 in order to stably mount the display panel 30. However, the frame 100 is maintained in a state of being bent at a predetermined curvature due to a springback phenomenon even when the flattening work is performed. That is, a front surface of the frame 100 may be in a bent state so that a difference between the highest portion and the lowest portion along the z axis direction has a first length d1. The rear surface of the frame 100 may be in a bent state so that a difference between the highest portion and the lowest portion along the z axis direction has a second length d2. The first length d1 and the second length d2 may be the same or different.

When the bent frame 100 is put on the processing jig 96 and fixed using a clamp (processing device), the frame 100 may be in a flat state by a force applied by the clamp (processing device). The frame 100, which has been temporarily flattened as above, returns to its original state and is bent again due to the springback phenomenon when the clamp (processing device) is released after the panel seating part 110 is processed using the processing device 92. Accordingly, the processed panel seating part 110 is also in a bent state.

The frame 100 of the display apparatus 1 according to an embodiment of the present disclosure may prevent the panel seating part 110 from being in a bent state due to the springback phenomenon. The frame 100 may undergo the flattening work to be aligned parallel to a plane perpendicular to the z axis before the panel seating part 110 is processed using the processing device 92. The frame 100 may undergo the flattening work by the correction jig 91 before processed by the processing device 92.

Specifically, referring to FIG. 5, after the correction member 130 is mounted on the frame 100 illustrated in FIG. 4, the frame 100 on which the correction member 130 is mounted may be mounted on the correction jig 91. An upper surface of the correction jig 91 may extend flat along an x-y plane. The frame 100 may be disposed such that the rear surface thereof is seated on the upper surface of the correction jig 91. The frame 100 may be disposed such that the member head 132 of the correction member 130 mounted on the frame 100 is in contact with the upper surface of the correction jig 91. In this case, because the frame 100 is in a bent state, when the correction member 130 is inserted into the frame 100 by the same depth, gaps may be generated between some of the plurality of correction members 130 and the correction jig 91.

Referring to FIG. 6, the correction member 130 generating the gap together with the correction jig 91 may be adjusted to be less inserted into the frame 100. The correction member 130 rotates in a direction of being separated from the frame 100 and may be adjusted to be in contact with the upper surface of the correction jig 91. That is, the correction member 130 may rotate along a −z direction. The correction member 130 may move along the −z direction by a third length d3. The third length d3 may correspond to a length obtained by subtracting a thickness of the member head 132 along the z-axis direction from the second length d2.

When the flattening work by the correction jig 91 is finished, the frame 100 may be moved to and seated on the processing jig 96.

The frame body 101 may include a clamp support portion 121 provided along the circumference of the correction hole 120 on the front surface opposite to a rear surface mounted on the processing jig 96. The clamp (processing device) is in contact with the clamp support portion 121 and may fix the frame body 101 together with the processing jig 96.

Specifically, referring to FIG. 7, the clamp (processing device) may press a portion of the frame to which the correction member 130 is coupled toward the processing jig 96. The clamp (processing device) may be in contact with the clamp support portion 121 of the frame 100. The clamp (processing device) may fix the frame 101 together with the processing jig 96. Because the member head 132 of the correction member 130 is adjusted to have the same height along the z axis direction, even when the clamp (processing device) presses and fixes the frame 100, the frame 100 is not deformed.

When the frame 100 is fixed by the processing jig 96 and the clamp (processing device), the processing device 92 may process the panel seating part 110 on the front surface of the frame 100. The processing device 92 may be provided as a milling machine. The processing device 92 may flatly process the panel seating part 110. The panel seating part 110 may be formed parallel to the upper surface of the correction jig 91.

Because the panel seating part 110 is formed in a state in which the correction member 130 corrects a flat degree of the frame 100, a flat degree of the panel seating part 110 and a flat degree of the rear surface of the frame 100 are different.

Specifically, referring to FIG. 8, even when the fixing by the clamp (processing machine) is released after the processing of the panel seating part 110 is finished, the springback phenomenon does not occur in the frame 100. That is, the front surface of the frame 100 is maintained such that the panel seating part 110 is formed flat along the x-y plane, and the rear surface of the frame 100 is maintained to have the second length d2 which is the difference between the highest portion and the lowest portion along the z-axis direction. That is, in a state in which the frame 100 is bent, the panel seating part 110 is formed flat.

When the processing of the panel seating part 110 by the processing device 92 is finished, the correction member 130 is separated from the frame 100. The plurality of display panels 30 may be mounted on the frame 100. Because the panel seating part 110 is formed flat, a step difference generated between the display panels 30 may be reduced.

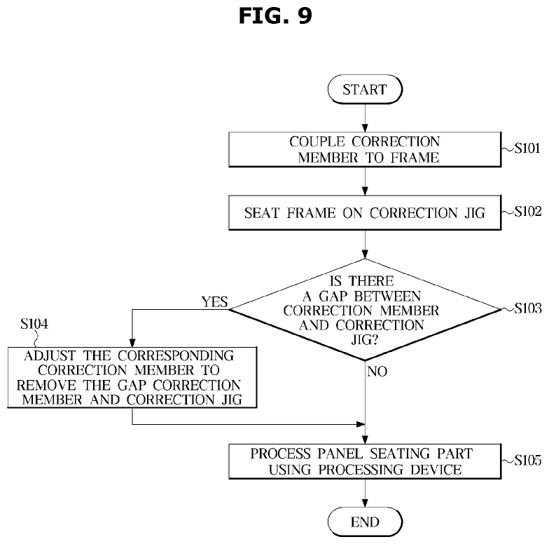

FIG. 9 is a flowchart illustrating a method of manufacturing a frame of a display apparatus according to an embodiment of the present disclosure.

Hereinafter, a method of manufacturing the frame 100 of the display apparatus 1 will be described with reference to FIG. 9.

First, the frame 100 made by die casting may undergo a flattening work by a physical external force. The external force may be applied to the frame 100 in a direction in which the frame 100 becomes flat. The correction hole 120 is formed on the frame 100 that has undergone the flattening work. The correction member 130 is coupled to the frame 100 on which the correction hole 120 is formed (S101).

The frame 100 to which the correction member 130 is coupled may be seated on the correction jig 91 formed flat (S102). The upper surface of the correction jig 91 may be provided parallel to the x-y plane.

A parallel inspection device (not shown) inspects whether a gap is generated between the member head 132 of the correction member 130 coupled to the frame 100 seated on the correction jig 91 and the upper surface of the correction jig 91 (S103). Based on the inspection result, the correction members 130 may be adjusted so that the member heads 132 and the correction jig 91 are all in contact with each other.

Specifically, when there is a gap between the member head 132 of the correction member 130 and the upper surface of the correction jig 91, the correction member 130 may adjust a degree to which the member head 132 is inserted into the frame 100 so that the member head 132 is in contact with the correction jig 91, and thus the gap between the correction member 130 and the correction jig 91 may be removed (S104).

More specifically, the correction member 130 may move by a predetermined distance in a direction of being separated from the frame 100 to be in contact with the correction jig 91. When a plurality of the correction members 130 is provided, the correction members 130 generating gaps together with the correction jig 91 may be adjusted.

As the gaps between the correction members 130 and the correction jig 91 are removed, when the member heads 132 of the correction members 130 are disposed on the same plane along the x-y plane, the frame 100 may be moved to and seated on the processing jig 96. The frame 100 moved to the processing jig 96 may be fixed by the clamp (processing machine). The clamp (processing machine) may press a portion of the frame 100 to which the correction member 130 is coupled. Because the frame 100 is aligned parallel to the x-y plane by the correction member 130, the frame 100 is not bent even when pressed by the clamp (processing machine).

On the frame 100 fixed by the clamp (processing machine), the panel seating part 110 may be formed by the processing device 92 (S105).

On the other hand, when there is no gap between the member head 132 of the correction member 130 and the upper surface of the correction jig 91, the frame 100 may be moved to the processing jig 96 and seated on the processing jig 96 without the adjusting process of the correction member 130. On the frame 100 seated on the processing jig 96, the panel seating part 110 may be formed by the processing device 92 (S105).

After the processing of the panel seating part 110 is finished, the clamp (processing machine) releases the fixing of the frame 100. Because the frame 100 is aligned parallel to the x-y plane by the correction member 130, the springback phenomenon does not occur.

In addition, because the frame 100 is aligned parallel to the x-y plane by the correction member 130, the panel seating part 110 may be formed to be parallel to the surface (x-y plane) with which the correction member 130 and the correction jig 91 have been in contact.

After the panel seating part 110 is formed, the correction member 130 may be separated from the frame 100.

Because a step is hardly generated between the panel seating parts 110 of the frame 100 made as above, even when the plurality of display panels 30 is mounted, the generation of steps may be reduced.

In addition, because the flattening work of the frame 100 is performed in the correction jig 91 disposed in a separate place from the processing jig 96 before the panel seating part 110 is seated on the processing jig 96 and processed through the processing device 92, the processing process on the processing jig 96 may be simplified, and processing efficiency may be improved.

The foregoing has illustrated and described specific embodiments. However, it should be understood by those of skilled in the art that the disclosure is not limited to the above-described embodiments, and various changes and modifications may be made without departing from the technical idea of the disclosure described in the following claims.

1. A display apparatus comprising:
a plurality of display panels;
a frame comprising panel seating parts on which the plurality of display panels is mounted and having a correction hole formed to penetrate along the front and rear directions; and
a control board disposed at the rear of the frame,
wherein the correction hole is provided such that a correction member to support a rear surface of the frame when the panel seating part is processed on the frame is inserted, and
the correction member is configured such that a degree of being inserted into the correction hole is adjusted when the panel seating part is processed on the frame.

2. The display apparatus according to claim 1, wherein
the correction hole has threads formed on an inner circumferential surface thereof, and
the correction member comprises a member body on which threads are formed to correspond to the correction hole.

3. The display apparatus according to claim 2, wherein
the correction member comprises:
a member head provided at one end of the member body to be in contact with a processing jig on which the frame is seated when the panel seating part is processed on the frame; and
a control groove provided at the other end opposite to the one end of the member body to receive an external force when a degree of being inserted into the correction hole is adjusted.

4. A method of manufacturing a display apparatus comprising:
coupling one or more correction members to a frame on which a plurality of display panels is to be mounted thereon;
seating the frame on a correction jig formed flat;
adjusting the correction members so that the one or more correction members and the correction jig are all in contact with each other;
moving and seating the frame to and on a processing jig; and
forming panel seating parts on the frame seated on the processing jig using a processing device.

5. The method according to claim 4, further comprising
checking whether gaps are generated between the one or more correction members and the correction jig before adjusting the correction members and then adjusting the correction member generating the gap together with the correction jig.

6. The method according to claim 5, further comprising
moving the correction member, which generates the gap together with the correction jig among the one or more correction members, by a predetermined distance in a direction of being separated from the frame.

7. The method according to claim 4, further comprising
separating the one or more correction members from the frame after forming the panel seating parts on the frame.

8. The method according to claim 4, further comprising
forming correction holes so that the one or more correction members are inserted into the frame before coupling the one or more correction members to the frame.

9. The method according to claim 8, wherein
the one or more correction members are provided to be screwed into the correction holes and have a control groove formed to receive an external force.

10. The method according to claim 4, further comprising
fixing the frame seated on the processing jig through a clamp.

11. The method according to claim 4, wherein
the panel seating parts are formed parallel to surfaces into which the one or more correction members and the correction jig are in contact.

12. The method according to claim 4, wherein
the panel seating parts are formed to support edges of rear surfaces of the plurality of display panels.

13. The method according to claim 4, wherein
the processing device is provided as a milling machine.

14. The method according to claim 4, wherein
the frame is provided by die casting.

15. The method according to claim 4, further comprising
applying an external force to the frame in a direction in which the frame is flattened before coupling the one or more correction members to the frame.
